(19) United States
(12) Patent Application Publication
(10) Pub. No.: US 2026/0260407 A1
(43) Pub. Date: Sep. 3, 2026

(54) RENDERING METHOD, APPARATUS AND DEVICE

(71) Applicant: Beijing Zitiao Network Technology Co., Ltd., Beijing (CN)

(72) Inventors: Hualong NING, Beijing (CN); Ruchong LUO, Beijing (CN)

(21) Appl. No.: 19/553,048

(22) Filed: Feb. 27, 2026

(30) Foreign Application Priority Data
Feb. 28, 2025 (CN) 202510240053.9

(51) Int. Cl. G06T 11/60

(52) U.S. Cl. CPC G06T 11/60; G06T 2210/32

(57) ABSTRACT

Provided are a rendering method and apparatus, and a device. The method includes: performing rendering on a first object in a multi-object material to obtain a first rendering result; performing rendering on a second object in the multi-object material to obtain a second rendering result; and obtaining a target rendering result of the multi-object material on the basis of the first rendering result and the second rendering result, the first object in the target rendering result presenting the first effect, and the second object in the target rendering result presenting the second effect.

### CROSS REFERENCE TO RELATED APPLICATIONS

This present application claims the benefit of priority to Chinese Application No. 202510240053.9, filed on February 28, 2025, the entire contents of which are incorporated herein by reference.

### TECHNICAL FIELD

The present application relates to the technical field of media processing and, in particular, to a rendering method, an apparatus and a device.

### BACKGROUND

In many scenarios, a material edited by a user on a media editing client may include a plurality of objects, which is referred to as a multi-object material in the present application. On the media editing client, in order to satisfy the user’s diversity requirements for a presentation effect of the multi-object material, post-processing corresponding to an effect such as blurring, glowing, masking, or the like may be performed on the multi-object material as a whole.

At present, in a media editing task, a rendering process of the multi-object material is to: draw objects in the multi-object material one by one, and then perform rendering of a post-processing effect on the drawn multi-object material as a whole.

### SUMMARY

Embodiments of the present application provide a rendering method, an apparatus and a device.

The technical solutions provided by the embodiments of the present application are as follows:

In a first aspect of the present application, a rendering method is provided, including:

performing, on a first object in a multi-object material, rendering of a first effect to obtain a first rendering result;

performing, on a second object in the multi-object material, rendering of a second effect to obtain a second rendering result; and

obtaining a target rendering result of the multi-object material based on the first rendering result and the second rendering result, where the first object in the target rendering result presents the first effect, and the second object in the target rendering result presents the second effect.

In some implementations, the performing, on the first object in the multi-object material, the rendering of the first effect to obtain the first rendering result includes:

performing, based on a first rendering function (such as renderGroup) corresponding to the first object, conversion processing on the first object to obtain first information corresponding to the first object, the first information including the first object in a picture format; and

performing, on the first object in the picture format, effect processing corresponding to the first effect to obtain the first rendering result.

In some implementations, the performing, on the second object in the multi-object material, the rendering of the second effect to obtain the second rendering result includes:

performing the rendering of the second effect on the multi-object material to obtain the second rendering result, and the first object in the target rendering result presents the first effect and the second effect.

In some other implementations, the obtaining the target rendering result of the multi-object material based on the first rendering result and the second rendering result includes:

saving the first rendering result into a slot corresponding to the first object, and saving the second rendering result into a slot corresponding to the second object; and

obtaining the target rendering result based on contents in the slots corresponding to respective objects in the multi-object material.

As an example, the obtaining the target rendering result based on the contents in the slots corresponding to respective objects in the multi-object material includes:

performing, based on the contents in the slots corresponding to respective objects in the multi-object material, rendering of a third effect on the multi-object material to obtain the target rendering result, the first object in the target rendering result presents the first effect and the third effect, and the second object in the target rendering result presents the second effect and the third effect.

As an example, the performing, based on the contents in the slots corresponding to respective objects in the multi-object material, the rendering of the third effect on the multi-object material to obtain the target rendering result includes:

performing, for contents in slots corresponding to respective objects in the multi-object material, conversion processing on the multi-object material to obtain second information corresponding to the multi-object material, the second information including the multi-object material in a picture format; and

performing, on the multi-object material in the picture format, effect processing corresponding to the third effect to obtain the target rendering result.

In some implementations, the multi-object material further includes a third object, and the method further includes:

performing, on the third object, the rendering of the first effect to obtain a third rendering result corresponding to the third object; and

saving the first rendering result and the third rendering result into a same slot, the slot corresponding to the first object or the third object.

In some implementations, the multi-object material further includes a fourth object, and the method further includes:

in response to setting a state of the fourth object to a first value, not presenting the fourth object in the target rendering result, a state of an object being the first value indicating that the object is not rendered.

In some implementations, the multi-object material is a text, and the first object is a character in the text; or, the multi-object material is a picture, and the object is a sticker or a local image in the picture.

In a second aspect of the present application, a rendering apparatus is further provided, including:

a first rendering unit, configured to perform, on a first object in a multi-object material, rendering of a first effect to obtain a first rendering result;

a second rendering unit, configured to perform, on a second object in the multi-object material, rendering of a second effect to obtain a second rendering result; and

a generating unit, configured to obtain a target rendering result of the multi-object material based on the first rendering result and the second rendering result, the first object in the target rendering result presents the first effect, and the second object in the target rendering result presents the second effect.

In some implementations, the first rendering unit is further configured to:

perform, based on a first rendering function (such as renderGroup) corresponding to the first object, conversion processing on the first object to obtain first information corresponding to the first object, the first information including the first object in a picture format; and

perform, on the first object in the picture format, effect processing corresponding to the first effect to obtain the first rendering result.

In some implementations, the second rendering unit is further configured to:

perform the rendering of the second effect on the multi-object material to obtain the second rendering result, and the first object in the target rendering result presents the first effect and the second effect.

In some other implementations, the generating unit includes:

a saving subunit, configured to save the first rendering result into a slot corresponding to the first object, and save the second rendering result into a slot corresponding to the second object; and

a rendering subunit, configured to obtain the target rendering result based on contents in the slots corresponding to respective objects in the multi-object material.

As an example, the rendering subunit is further configured to:

perform, based on the contents in the slots corresponding to respective objects in the multi-object material in the multi-object material, rendering of a third effect on the multi-object material to obtain the target rendering result, the first object in the target rendering result presents the first effect and the third effect, and the second object in the target rendering result presents the second effect and the third effect.

As an example, the rendering subunit is further configured to:

perform, for contents in slots corresponding to respective objects in the multi-object material, conversion processing on the multi-object material to obtain second information corresponding to the multi-object material, the second information including the multi-object material in a picture format; and

perform, on the multi-object material in the picture format, effect processing corresponding to the third effect to obtain the target rendering result.

In some implementations, the multi-object material further includes a third object, and the apparatus further includes:

a third rendering unit, configured to perform, on the third object, the rendering of the first effect to obtain a third rendering result corresponding to the third object; and

a saving unit, configured to save the third rendering result into the slot where the first rendering result is located, the slot corresponding to the first object or the third object.

In some implementations, the multi-object material further includes a fourth object, and the apparatus further includes:

a processing unit, configured to, in response to setting a state of the fourth object to a first value, not present the fourth object in the target rendering result, a state of an object being the first value indicating that the object is not rendered.

In some implementations, the multi-object material is a text, and the first object is a character in the text; or, the multi-object material is a picture, and the object is a sticker or a local image in the picture.

In a third aspect of the present application, an electronic device is provided, the electronic device includes: a processor and a memory, the memory is configured to store instructions or a computer program, and the processor is configured to execute the instructions or the computer program in the memory to cause the electronic device to perform the method provided in the first aspect or any implementation of the first aspect.

In a fourth aspect of the present application, a computer-readable storage medium is provided, the computer-readable storage medium stores instructions, and the instructions, when executed by a processor, cause the processor to perform the method provided in the first aspect or any implementation of the first aspect.

In a fifth aspect of the present application, a computer program product is provided, the computer program product includes a computer program or instructions, and the computer program or instructions, when executed by a processor, implement the method provided in the first aspect or any implementation of the first aspect.

In the present application, a rendering method is provided, and the method may include, for example: performing, on a first object in a multi-object material, rendering of a first effect to obtain a first rendering result; performing, on a second object in the multi-object material, rendering of a second effect to obtain a second rendering result; and thus, obtaining a target rendering result of the multi-object material based on the first rendering result and the second rendering result, the first object in the target rendering result presents the first effect, and the second object in the target rendering result presents the second effect.

### BRIEF DESCRIPTION OF THE DRAWINGS

In order to more clearly illustrate the technical solutions in the embodiments of the present application or in the related art, the drawings required in describing the embodiments or the related art will be briefly introduced below. Obviously, the drawings in the following description show merely some embodiments of the present application, and persons of ordinary skill in the art may still derive other drawings from these drawings without creative efforts.

FIG. 1 is a schematic flowchart of rendering of a text including a plurality of characters in a current media editing task;

FIG. 2 is a schematic flowchart of an example of a rendering method provided in an embodiment of the present application;

FIG. 3 is a schematic diagram of drawing of respective parts in the process shown in FIG. 2;

FIG. 4 is a schematic flowchart of a rendering method provided in an embodiment of the present application;

FIG. 5 is a schematic diagram of a structure of a rendering apparatus 500 provided in an embodiment of the present application; and

FIG. 6 is a schematic diagram of a structure of an electronic device 600 provided in an embodiment of the present application.

### DETAILED DESCRIPTION OF EMBODIMENTS

In order for persons skilled in the art to better understand the solutions of the present application, the technical solutions in the embodiments of the present application will be described below clearly and completely with reference to the drawings in the embodiments of the present application. Obviously, the described embodiments are merely some rather than all of the embodiments of the present application. All other embodiments obtained by persons of ordinary skill in the art based on the embodiments of the present application without creative efforts fall within the scope of protection of the present application.

When a user edits media content on a media editing client, in many cases, the media content may include a multi-object material. The multi-object material may be understood as a material including a plurality of objects, where the objects may include but are not limited to characters, stickers or local images, and the material may include but is not limited to a text or a picture. The plurality of objects in the multi-object material may be objects of a same type, and the multi-object material may refer to, for example, a text including a plurality of characters, or for example, a picture including a plurality of stickers, or for example, a picture including a plurality of local images. Alternatively, the plurality of objects in the multi-object material may be objects of different types, and the multi-object material may refer to, for example, a material including at least two of characters, stickers or local images. In the following, the embodiments of the present application are introduced by using an example in which the multi-object material is a text including a plurality of characters, and for rendering manners of other multi-object materials, reference may be made to the rendering manner of the text including the plurality of characters.

For higher-quality and richer display effects, in addition to elements such as an outline, a fill, a shadow, or the like, a post-processing effect may further be added to the multi-object material. Post-processing refers to a process of adding an effect such as blurring, distorting, glowing, masking, or the like to a drawn overall image after each object of the multi-object material is drawn according to the set elements. The post-processing effect may refer to an effect that may be added to the overall image drawn according to the elements of each object, and may include but is not limited to blurring, distorting, glowing or masking.

At present, the post-processing of the multi-object material may only be performed on the multi-object material as a whole, that is, a picture obtained by drawing the multi-object material according to the elements is used as a post-processing target, and separate post-processing cannot be performed on a certain object or some objects in the multi-object material. This rendering manner only supports adding the post-processing effect to the multi-object material as a whole, which is not flexible and user-friendly enough, and cannot satisfy the user’s increasing requirements for effect post-processing in multi-object material rendering. In order to provide a more flexible and user-friendly use experience for the user, the media editing client needs a more flexible rendering solution that is able to add post-processing effects to some objects in the multi-object material.

Based on this, an embodiment of the present application provides a rendering method, which is able to add an effect to any object in a multi-object material individually, thereby making rendering of the multi-object material more flexible, improving performance of a media editing task, and improving a user’s use experience on a media editing client. The method may include, for example: performing, on a first object in a multi-object material, rendering of a first effect to obtain a first rendering result; performing, on a second object in the multi-object material, rendering of a second effect to obtain a second rendering result; and thus, obtaining a target rendering result of the multi-object material based on the first rendering result and the second rendering result, the first object in the target rendering result presents the first effect, and the second object in the target rendering result presents the second effect.

It may be seen that, through this method, a media editing client provides a function of separately adding a post-processing effect to each object in the multi-object material for a user’s media editing task, which makes it possible to separately design and render the post-processing effect for some objects in the multi-object material, and is more flexible and user-friendly for the user’s media editing task, and may satisfy the user’s richer requirements for effect post-processing in multi-object material rendering.

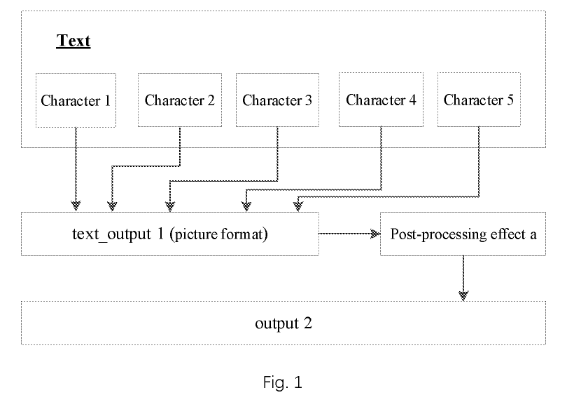

Taking an example in which the multi-object material is a text including character 1, character 2, character 3, character 4 and character 5, and a post-processing effect a is added to the text, a current rendering method is shown in FIG. 1, and the process may include: S11, drawing, for each character included in the text, the character according to elements to obtain a text output (text_output) 1, and the text output 1 may be in a picture format; and S12, performing, on the text output 1, rendering of the post-processing effect a to obtain a final output (output) 2.

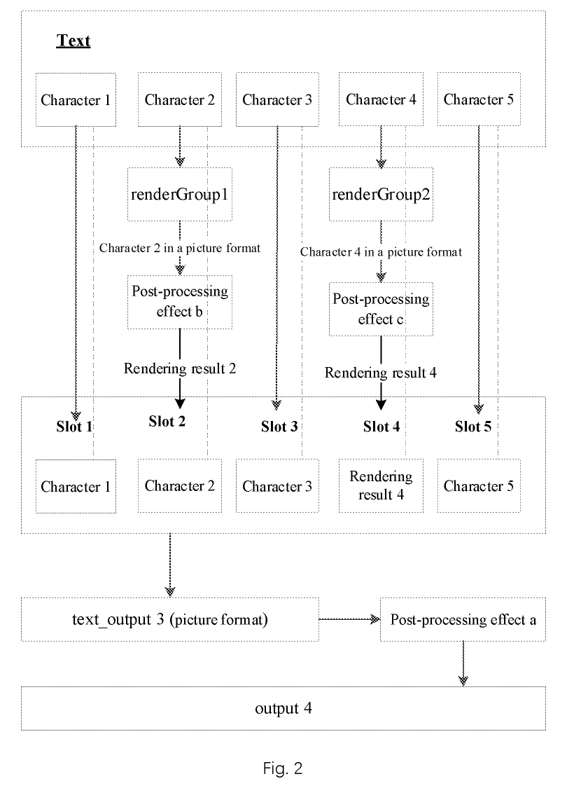

As a comparison, still taking an example in which the multi-object material is a text including character 1, character 2, character 3, character 4 and character 5, a post-processing effect b is added to character 2, a post-processing effect c is added to character 4, and a post-processing effect a is added to the text, a rendering method provided in an embodiment of the present application is shown in FIG. 2, and the process may include: S21, in response to user operations of setting the post-processing effect b for character 2, setting the post-processing effect c for character 4, and setting the post-processing effect a for the entire text, dividing the text into 5 slots, corresponding to character 1 to character 5, respectively, and corresponding a rendering function 1 to character 2, and corresponding a rendering function 2 to character 4, the rendering function 1 and the rendering function 2 may be, for example, renderGroup. S22, directly filling character 1, character 3 and character 5 into a corresponding slot 1, a corresponding slot 3 and a corresponding slot 5, respectively; obtaining, by passing character 2 through the rendering function 1, a corresponding character 2 in a picture format, performing, on the character 2 in the picture format, rendering of the post-processing effect b, and filling a rendering result 2 into a slot 2; and similarly, obtaining, by passing character 4 through the rendering function 2, a corresponding character 4 in a picture format, performing, on the character 4 in the picture format, rendering of the post-processing effect c, and filling a rendering result 4 into a slot 4. S23, rendering, by taking the text including the slot 1 to the slot 5 as a whole, to obtain a text output (text_output) 3 in a picture format. S24, performing, on the text output 3, rendering of the post-processing effect a to obtain a final output (output) 4.

In S22, separate post-processing effects are rendered for character 2 and character 4, respectively, which is performed before the overall post-processing effect is rendered, and therefore may be understood as rendering in advance. The rendering in advance may separately add an additional post-processing effect to one or more objects without affecting the rendering of the final overall post-processing effect.

It should be noted that, in the final rendering result, the post-processing effect rendered in advance and the overall post-processing effect may be superimposed. For example, in output 4, the post-processing effect of character 1, character 3 and character 5 is the post-processing effect a, character 2 is a post-processing effect of the post-processing effect b + the post-processing effect a, and character 4 is a post-processing effect of the post-processing effect c + the post-processing effect a.

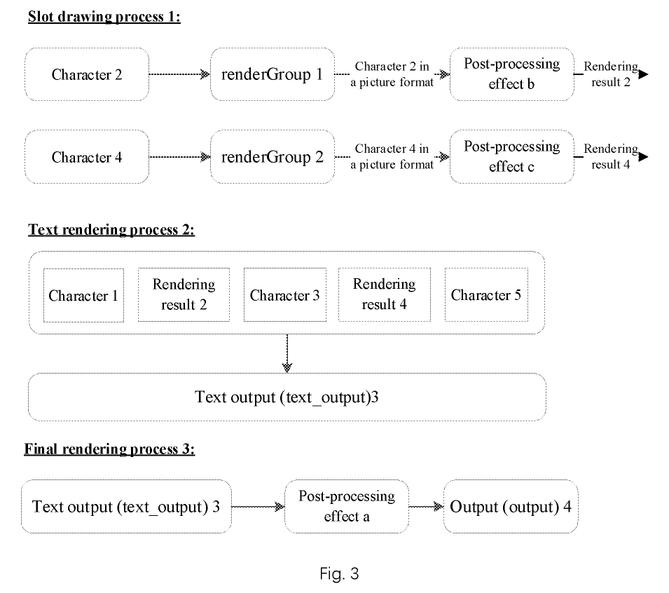

Taking an example in which the rendering function is renderGroup, referring to what FIG. 3 shows, the rendering process shown in FIG. 2 may include a slot drawing process 1, a text rendering process 2, and a final rendering process 3.

The slot drawing process 1 may include: drawing character 1, character 3 and character 5 into a corresponding slot 1, a corresponding slot 3 and a corresponding slot 5; passing character 2 through renderGroup processing 1 to obtain character 2 in a picture format, and performing, on the character 2 in the picture format, rendering of the post-processing effect b to obtain a rendering result 2, thereby drawing a rendering effect 2 into a corresponding slot 2; and passing character 4 through renderGroup 2 processing to obtain character 4 in a picture format, and performing, on the character 4 in the picture format, rendering of the post-processing effect c to obtain a rendering result 4, thereby drawing a rendering effect 4 into a corresponding slot 4.

The text rendering process 2 may include: performing overall drawing on a text including character 1, the rendering result 2, character 3, the rendering result 4 and character 5 to obtain a text in a picture format, that is, a text output (text_output) 3.

The final rendering process 3 may include: performing, on the text output (text_output) 3, rendering of the post-processing effect a to obtain a final rendering result, that is, an output (output) 4.

In this way, according to user requirements, the post-processing effect may be flexibly added to a character in the text including a plurality of characters separately without affecting the overall post-processing effect of the text, thereby improving the user’s use experience on the media editing client.

It should be noted that, in the embodiments of the present application, drawing and rendering may indicate a same meaning, and occurrences thereof may be understood as interchangeable without affecting the implementation of the embodiments of the present application.

It should be noted that, the slot in the embodiments of the present application may be understood as a buffer unit configured to store a rendering intermediate state image of each character.

It should be noted that, a subject performing the rendering method may be a rendering apparatus provided in an embodiment of the present application. The rendering apparatus may be carried in an electronic device or a functional module of the electronic device. The rendering apparatus may be, for example, a functional module on a network device such as a server or a terminal device such as a mobile phone, and the functional module is configured to implement the rendering function provided in the embodiments of the present application. For example, the rendering apparatus may be a module on a media editing client on the terminal device, and the module is configured to implement the rendering function provided in the embodiments of the present application.

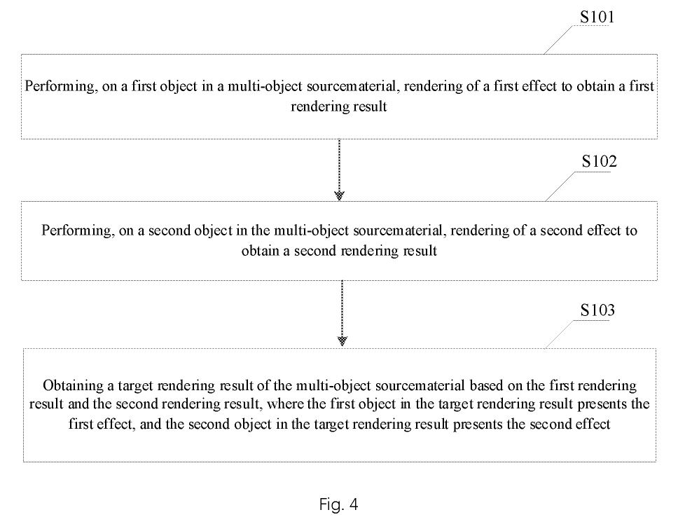

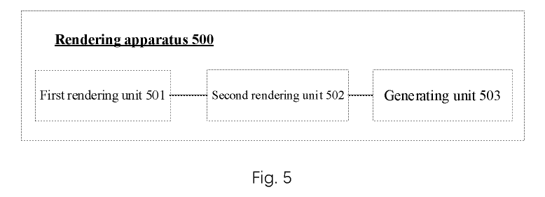

FIG. 4 is a schematic flowchart of a rendering method provided in an embodiment of the present application. The method may be applied to a rendering apparatus, and the rendering apparatus may be, for example, a rendering apparatus 500 shown in FIG. 5 below.

As shown in FIG. 4, the method may include the following S101 to S103, for example:

S101, performing, on a first object in a multi-object material, rendering of a first effect to obtain a first rendering result.

S102, performing, on a second object in the multi-object material, rendering of a second effect to obtain a second rendering result.

It may be understood that, in a media editing task, a first operation of adding the first effect to the first object in the multi-object material, and a second operation of adding the second effect to the second object in the multi-object material may be included. Then, in response to the first operation, S101 is performed; and similarly, in response to the second operation, S102 is performed.

It should be noted that, if the second effect is only for the second object rather than for the multi-object material as a whole, the execution order of S101 and S102 is not limited. If the second effect is for the multi-object material as a whole, S102 needs to be executed after S101, and the execution of S102 needs to be implemented on the basis of the first rendering result.

It may be understood that, in the embodiments of the present application, when a user performs a media editing task on the media editing client, if the media content edited in the media editing task includes a multi-object material, the user may add a post-processing effect to the multi-object material as a whole based on requirements, and may also separately add a corresponding post-processing effect to each object in the multi-object material, so as to satisfy the user’s more diverse and flexible requirements for the media editing task.

The multi-object material may refer to a material including a plurality of objects, and the plurality of objects are specific contents of the material. For example, the multi-object material is a text including a plurality of characters, and for another example, the multi-object material is a picture including a plurality of stickers or small images (which may also be referred to as local images).

The first object and the second object may be understood as any objects that need to be added a post-processing effect separately among the plurality of objects included in the multi-object material. Taking an example in which the multi-object material is a text including four characters of "默认显示", if a character that the user needs to add post-processing separately includes "认", the first object may refer to the character "认". The post-processing effect added separately to the first object is the first effect in S101. Correspondingly, if the second effect is an effect separately corresponding to the second object, for example, the characters that the user needs to add post-processing separately further include "默", then the second object may refer to the character "default", and the post-processing effect added separately to the second object is the second effect in S102; or, the second effect may also be a post-processing effect added to the multi-object material as a whole.

The first operation may refer to an operation that the user needs to perform on the media editing client to add the first effect to the first object in the multi-object material in the media editing task. For example, the first operation may be an operation of: clicking on a track where the "multi-object material" is located, selecting the first object among the objects included in the "multi-object material", and selecting the first effect in an "animation" option, which is performed by the user in the media editing task created on the media editing client.

If the second operation only corresponds to the second object, for the description of the second operation, reference may be made to the relevant description of the first operation. If the second operation corresponds to the multi-object material as a whole, the second operation may refer to an operation that the user needs to perform on the media editing client to add the second effect to the multi-object material in the media editing task. For example, the second operation may be an operation of: clicking on the track where the "multi-object material" is located, and selecting the second effect in the "animation" option, which is performed by the user in the media editing task created on the media editing client; or, the second operation may be an operation of: selecting all objects in the "multi-object material" and selecting the second effect in the "animation" option, which is performed by the user in the media editing task created on the media editing client.

Still taking an example in which the multi-object material is the text including the four characters of "默认显示", the first object is the character "认", and the second object is "默", assuming that the second effect is blurring and the first effect is glowing, the first operation may be: clicking on the track where "默认显示" is located (this step may be omitted if the "默认显示" is currently in an editing state), selecting "认" in "默认显示", and selecting "glowing" in the "animation" option. If the second effect corresponds to the multi-object material as a whole, the second operation may be: clicking on the track where "默认显示" is located, and selecting "blurring" in the "animation" option; if the second effect only corresponds to the second object, the second operation may be: clicking on the track where "默认显示" is located (this step may be omitted if the "默认显示" is currently in an editing state), selecting "默认" in "默认显示", and selecting "blurring" in the "animation" option.

It should be noted that, after the user performs the first operation and the second operation, the embodiments of the present application are triggered to be implemented, that is, the rendering apparatus provided in the embodiments of the present application may perform the method provided in the embodiments of the present application to implement flexible rendering of the multi-object material.

It should be noted that, the execution order of the first operation and the second operation performed by the user on the multi-object material is not limited, that is, the first operation may be performed first and then the second operation is performed, or the second operation may be performed first and then the first operation is performed.

In some possible implementations, a first rendering function may be correspondingly provided for the first object, to which a post-processing effect needs to be added separately, in the multi-object material, and the first rendering function may process the first object into the first object in the picture format. For the case where the multi-object material is a text including a plurality of characters, the first rendering function may be, for example, renderGroup, and renderGroup may convert a first character into a picture format.

As an example, in the rendering apparatus, each object, to which a post-processing effect needs to be added separately, may correspond to one rendering function, and the rendering function is configured to process the object into an object in a picture format, thereby making it possible to separately render the post-processing effect for the object. In this example, each object in the multi-object material may correspond to one slot, that is, when designing slots, the number of slots consistent with the number of objects included in the multi-object material is set, and the slots are in one-to-one correspondence with the objects in the multi-object material. Assuming that the multi-object material is a text including four characters of "默认显示", and the first object is the character "认", renderGroup 1 may be set for the character "认", and corresponding slot 1 to corresponding slot 4 are set for the characters "默", "认", "显" and "示", respectively.

As another example, if there are a plurality of objects, to which post-processing effects need to be added separately, in the multi-object material, and the post-processing effects added separately to at least two objects are the same, then the at least two objects, to which the same post-processing effect is added separately, may also correspond to one rendering function in the rendering apparatus. For example, the multi-object material further includes a third object, and in response to a third operation of adding the first effect to the third object in the media editing task, after the rendering of the first effect is performed on the third object to obtain a third rendering result corresponding to the third object, the third rendering result may be saved into a slot corresponding to the third object. In this example, in the target rendering result obtained through the following S103, the first effect is at least presented on the third object.

In this example, in one case, the at least two objects, to which the same post-processing effect is added separately, are objects in consecutive positions in the multi-object material. In this case, the at least two objects, to which the same post-processing effect is added separately, may correspond to one slot, that is, the designed number of slots may be less than the number of objects included in the multi-object material; or, the number of slots consistent with the number of objects included in the multi-object material may still be set, but since the rendering result after the post-processing effect is added separately to the at least two objects, to which the same post-processing effect is added separately, may be saved into the slot corresponding to any one of the at least two objects, to which the same post-processing effect is added separately, for the slot without saved content, the content thereof is empty, and may not be considered when the plurality of slots are rendered as a whole. For example, the first object and the third object described above may be two consecutive objects in the multi-object material, and the third operation and the first operation may be one operation or two operations performed by the user, which does not affect the implementation of the embodiments of the present application.

In this example, in another case, the positions of the at least two objects, to which the same post-processing effect is added separately, in the multi-object material may also be non-consecutive. In this case, in order to make the objects in the final rendering result present an order consistent with that of the objects in the multi-object material, position indications of the at least two objects, to which the same post-processing effect is added separately, in the multi-object material may be respectively added to the at least two objects. In this case, the designed number of slots may be less than or equal to the number of objects included in the multi-object material, which is the same as the related implementation of the previous case.

Assuming that the multi-object material is a text including four characters of "默认显示", the first object is the character "默", the third object is the character "认", and the post-processing effect added separately to the characters "默" and "认" is "glowing", then renderGroup 1 may be set for the characters "默" and "认", and a corresponding slot 1 is set for the characters "默" and "认", and corresponding slot 3 and corresponding slot 4 are set for the characters "显" and "示", respectively. If, at the beginning of design, the same number of slots as the number of objects are set, that is, slot 2 is set, since the content of slot 2 is empty, slot 2 does not participate in rendering after S103.

In some possible implementations, in response to the first operation and the second operation, S101 may be performed first. As an example, S101 may include, for example: the rendering apparatus performs, based on a first renderGroup corresponding to the first object, conversion processing on the first object to obtain first information corresponding to the first object, the first information may include the first object in a picture format; and then, the rendering apparatus performs, on the first object in the picture format, effect processing corresponding to the first effect to obtain the first rendering result. It should be noted that, in addition to the first object in the picture format, the first information may further include attribute information of the first object, and the attribute information is used to describe a feature of the first object in the rendering result of the multi-object material, for example, the attribute information may include but is not limited to: a width of the first object, and a height of the first object.

After S101, the rendering apparatus may save the first rendering result into the slot corresponding to the first object; if the second effect only corresponds to the second object, after S102, the rendering apparatus may save the second rendering result into the slot corresponding to the second object. In addition, the rendering apparatus may also directly save an object, to which a post-processing effect is not added separately, into a corresponding slot. In this way, the content of each object in the multi-object material required for the final rendering is prepared, which is ready for obtaining the final target rendering result.

S103, obtaining a target rendering result of the multi-object material based on the first rendering result and the second rendering result, where the first object in the target rendering result presents the first effect, and the second object in the target rendering result presents the second effect.

Taking an example in which the second effect only corresponds to the second object, S103 may include, for example: processing the multi-object material based on the contents in the slots corresponding to the respective objects in the multi-object material to obtain a target rendering effect.

In some possible implementations, if no effect is added to the multi-object material as a whole, S103 may include, for example: performing, based on the contents in the slots corresponding to the respective objects in the multi-object material, processing such as format conversion on the multi-object material to obtain the target rendering result, the first object in the target rendering result presents the first effect, and the second object presents the second effect.

In some other possible implementations, a third effect may be added to the multi-object material as a whole, and then, S103 may include, for example: performing, based on the contents in the slots corresponding to the respective objects in the multi-object material, rendering of the third effect on the multi-object material to obtain the target rendering result, the first object in the target rendering result presents the first effect and the third effect, and the second object in the target rendering result presents the second effect and the third effect.

As an example, the performing the rendering of the third effect on the multi-object material to obtain the target rendering result corresponding to the media editing task may include, for example: performing, for contents in slots corresponding to respective objects in the multi-object material, conversion processing on the multi-object material to obtain second information corresponding to the multi-object material, the second information including the multi-object material in a picture format; and performing, on the multi-object material in the picture format, effect processing corresponding to the third effect to obtain the target rendering result. It should be noted that, in addition to the multi-object material in the picture format, the second information may further include attribute information of the multi-object material, and the attribute information is used to describe a feature in the rendering result of the multi-object material, for example, the attribute information may include but is not limited to: a width of the multi-object material, and a height of the multi-object material.

In the process shown in FIG. 1, the first object, to which the post-processing effect is added separately, is taken as an example for description, and in the embodiments of the present application, at least one post-processing effect may be added to each object in the multi-object material based on requirements, and the post-processing effects separately added to each object may be the same or different. For the second object, to which the second effect is added separately, the method may further include: performing the above S102 in response to the second effect added to the second object in the media editing task, and the second effect and the third effect are presented on the second object in the obtained target rendering result. In this way, through the method provided in the embodiments of the present application, different post-processing effects may be flexibly added to different objects in the multi-object material, which makes the rendering of the multi-object material more flexible.

In some possible implementations, in the embodiments of the present application, a corresponding slot is set for each object in the multi-object material, respectively, which may facilitate a flexible setting of a state of each object during rendering. If there is a requirement of not displaying a certain object, the corresponding object in the multi-object material may not be deleted, but the state set for the object is set to a false state, then a fourth object may not be saved into the corresponding slot, and the slot is empty, and therefore, the fourth object is not included in the target rendering result; or, the fourth object may be saved in the corresponding slot, and the false state of the fourth object also corresponds to this slot, and for the slot with the false state, the content in the slot is not rendered in S103, and thus, the fourth object is not included in the target rendering result. For example, the multi-object material further includes the fourth object, and when the user wants not to display the fourth object after the rendering of the multi-object material, the method may further include: in response to setting a state of the fourth object to a first value, not presenting the fourth object in the second rendering result, a state of an object being the first value indicating that the object is not rendered. In this way, the rendering apparatus may more flexibly satisfy the user’s requirements, and more flexible and intelligent rendering may be implemented.

It may be seen that, through this method, the media editing client provides a function of separately adding a post-processing effect to each object in the multi-object material for the user’s media editing task, and corresponds the objects in the multi-object material to different slots, the rendering result of the object, to which the post-processing effect is added separately, after the rendering of the post-processing effect is saved in the slot corresponding to the object, and the object itself is saved in the slot corresponding to the other object, to which the post-processing effect is not added separately, and the overall post-processing effect is rendered based on the contents in the plurality of slots, which makes it possible to separately design and render the post-processing effect for some objects in the multi-object material, and then the overall post-processing effect is rendered based on the result obtained through separate rendering, which is more flexible and user-friendly for the user’s media editing task, and may satisfy the user’s richer requirements for effect post-processing in multi-object material rendering.

Correspondingly, an embodiment of the present application further provides a rendering apparatus 500, as shown in FIG. 5. The apparatus 500 may include:

a first rendering unit 501, configured to perform, on a first object in a multi-object material, rendering of a first effect to obtain a first rendering result;

a second rendering unit 502, configured to perform, on a second object in the multi-object material, rendering of a second effect to obtain a second rendering result; and

a generating unit 503, configured to obtain a target rendering result of the multi-object material based on the first rendering result and the second rendering result, the first object in the target rendering result presents the first effect, and the second object in the target rendering result presents the second effect.

In some implementations, the first rendering unit 501 is further configured to:

perform, based on a first rendering function (such as renderGroup) corresponding to the first object, conversion processing on the first object to obtain first information corresponding to the first object, the first information including the first object in a picture format; and

perform, on the first object in the picture format, effect processing corresponding to the first effect to obtain the first rendering result.

In some implementations, the second rendering unit 502 is further configured to:

perform the rendering of the second effect on the multi-object material to obtain the second rendering result, and the first object in the target rendering result presents the first effect and the second effect.

In some other implementations, the generating unit 503 includes:

a saving subunit, configured to save the first rendering result into a slot corresponding to the first object, and save the second rendering result into a slot corresponding to the second object; and

a rendering subunit, configured to obtain the target rendering result based on contents in the slots corresponding to respective objects in the multi-object material.

As an example, the rendering subunit is further configured to:

perform, based on the contents in the slots corresponding to respective objects in the multi-object material, rendering of a third effect on the multi-object material to obtain the target rendering result, the first object in the target rendering result presents the first effect and the third effect, and the second object in the target rendering result presents the second effect and the third effect.

As an example, the rendering subunit is further configured to:

perform, for contents in slots corresponding to respective objects in the multi-object material, conversion processing on the multi-object material to obtain second information corresponding to the multi-object material, the second information including the multi-object material in a picture format; and

perform, on the multi-object material in the picture format, effect processing corresponding to the third effect to obtain the target rendering result.

In some implementations, the multi-object material further includes a third object, and the apparatus 500 further includes:

a third rendering unit, configured to perform, on the third object, the rendering of the first effect to obtain a third rendering result corresponding to the third object; and

a saving unit, configured to save the third rendering result into the slot where the first rendering result is located, the slot corresponding to the first object or the third object.

In some implementations, the multi-object material further includes a fourth object, and the apparatus 500 further includes:

a processing unit, configured to, in response to setting a state of the fourth object to a first value, not present the fourth object in the target rendering result, a state of an object being the first value indicating that the object is not rendered.

In some implementations, the multi-object material is a text, and the first object is a character in the text; or, the multi-object material is a picture, and the object is a sticker or a local image in the picture.

It should be noted that, for the specific implementation and the technical effect achieved of the apparatus 500, reference may be made to the relevant description of the method shown in the embodiments of the present application.

In addition, an embodiment of the present application further provides an electronic device, the electronic device includes a processor and a memory, the memory is configured to store instructions or a computer program, and the processor is configured to execute the instructions or the computer program in the memory to cause the electronic device to perform any implementation of the method provided in the embodiments of the present application.

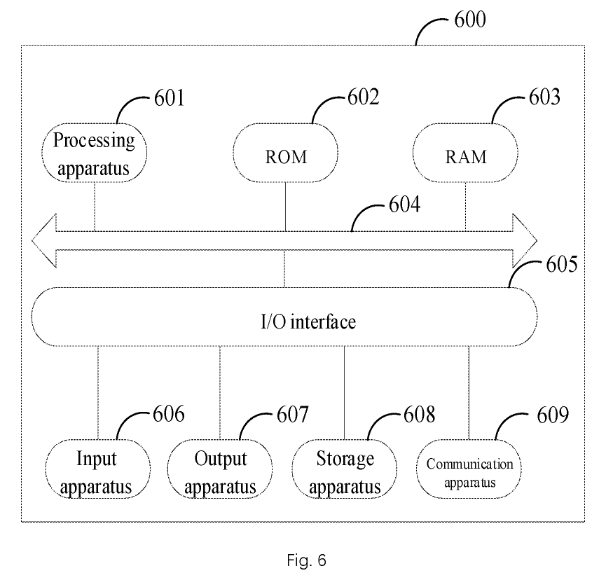

Referring to FIG. 6, it shows a schematic diagram of a structure of an electronic device 600 suitable for implementing an embodiment of the present disclosure. The terminal device in the embodiments of the present disclosure may include, but are not limited to, mobile terminals such as a mobile phone, a laptop, a digital broadcast receiver, a personal digital assistant (PDA), a tablet computer (PAD), a portable media player (PMP), an in-vehicle terminal (such as an in-vehicle navigation terminal), etc., and stationary terminals such as a digital TV, a desktop computer, etc. The electronic device shown in FIG. 6 is only an example, and should not impose any limitation to the function and scope of use of the embodiments of the present disclosure.

As shown in FIG. 6, the electronic device 600 may include a processing apparatus (such as a central processing unit, a graphics processing unit, etc.) 601, which may perform various appropriate actions and processing according to a program stored in a read-only memory (ROM) 602 or a program loaded from a storage apparatus 608 into a random access memory (RAM) 603. The RAM 603 further stores various programs and data required for operations of the electronic device 600. The processing apparatus 601, the ROM 602 and the RAM 603 are interconnected by means of a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, a gyroscope, or the like; an output apparatus 607 including, for example, a liquid crystal display (LCD), a loudspeaker, a vibrator, or the like; the storage apparatus 608 including, for example, a magnetic tape, a hard disk, or the like; and a communication apparatus 609. The communication apparatus 609 may allow the electronic device 600 to communicate wirelessly or wiredly with other devices to exchange data. Although FIG. 6 shows the electronic device 600 having various apparatuses, it should be understood that not all of the shown apparatuses are necessarily implemented or included. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, the computer program contains program codes for performing the method shown in the flowchart. In such an embodiment, the computer program may be downloaded and installed from a network via the communication apparatus 609, or installed from the storage apparatus 608, or installed from the ROM 602. When the computer program is executed by the processing apparatus 601, the above-mentioned functions defined in the method of the embodiments of the present disclosure are executed.

The electronic device provided in the embodiments of the present disclosure belongs to the same inventive concept as the method provided in the above-mentioned embodiments, and for technical details not described in detail in this embodiment, reference may be made to the above-mentioned embodiments, and this embodiment has the same beneficial effects as the above-mentioned embodiments.

An embodiment of the present application further provides a computer-readable medium, the computer-readable medium stores instructions or a computer program, and the instructions or the computer program, when executed by a device, cause the device to perform any implementation of the method provided in the embodiments of the present application.

It should be noted that the above-mentioned computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semi-conductive system, apparatus or device, or any suitable combination of the above. More specific examples of the computer-readable storage medium may include, but are not limited to: an electrically connected portable computer magnetic disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or used in conjunction with an instruction execution system, apparatus or device. In the present disclosure, the computer-readable signal medium may include a data signal propagated on a baseband or as a part of a carrier wave, and computer-readable program codes are carried in the data signal. This propagated data signal may be in multiple forms, and includes, but is not limited to, an electromagnetic signal, an optical signal, or any suitable combination of the above. The computer-readable signal medium may also be any computer-readable medium other than the computer-readable storage medium, and the computer-readable signal medium may send, propagate or transmit a program used by or in conjunction with an instruction execution system, apparatus or device. The program codes contained on the computer-readable medium may be transmitted by any suitable medium, including, but not limited to: a wire, an optical cable, a radio frequency (RF), or any suitable combination of the above.

The above-mentioned computer-readable medium may be included in the above-mentioned electronic device, or may exist alone without being assembled into the electronic device.

The above-mentioned computer-readable medium carries one or more programs, and when the one or more programs are executed by the electronic device, the electronic device may perform the above-mentioned method.

Computer program codes for performing the operations in the present disclosure may be written in one or more programming languages or a combination thereof, the above-mentioned programming languages include but are not limited to object-oriented programming languages, such as Java, Smalltalk, C++, and further include conventional procedural programming languages, such as "C" language or similar programming languages. The program codes may be completely executed on a user’s computer, partially executed on the user’s computer, executed as an independent software package, partially executed on the user’s computer and partially executed on a remote computer, or completely executed on the remote computer or server. In the case of involving the remote computer, the remote computer may be connected to the user’s computer through any kind of network, including a local area network (LAN) or a wide area network (WAN), or may be connected to an external computer (for example, connected by using Internet provided by an Internet service provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, program segment, or portion of code, which includes one or more executable instructions for implementing the specified logical function(s). It should also be noted that, in some alternative implementations, the functions noted in the block may occur in an order different from that noted in the figures. For example, two blocks shown in succession may, in fact, be executed substantially concurrently, or the blocks may sometimes be executed in a reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

The involved units described in the embodiments of the present disclosure may be implemented by means of software, and may also be implemented by means of hardware. The name of a unit/module does not constitute a limitation on the unit itself under certain circumstances.

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semi-conductive system, apparatus or device, or any suitable combination of the above. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that, various embodiments in this specification are described in a progressive manner, each embodiment focuses on a difference from other embodiments, and for the same and similar parts between the various embodiments, reference may be made to each other. For the system or apparatus disclosed in the embodiments, since it corresponds to the method disclosed in the embodiments, the description is relatively simple, and for the related parts, reference may be made to the description of the method.

It should be understood that, in the present application, "at least one (item)" refers to one or more, and "a plurality of" refers to two or more. "And/or", which is used to describe an association relationship between associated objects, indicates that three relationships may exist, for example, "A and/or B" may indicate: only A exists, only B exists, and both A and B exist, where A and B may be singular or plural. The character "/" generally indicates an "or" relationship between the associated objects. "At least one of the following items (pieces)" or a similar expression thereof refers to any combination of these items, including a single item (piece) or any combination of a plurality of items (pieces). For example, at least one of a, b or c may represent: a, b, c, "a and b", "a and c", "b and c", or "a, b and c", where a, b and c may be single or multiple.

It also needs to be noted that, in this text, relational terms such as first and second are only used to distinguish one entity or operation from another entity or operation, and do not necessarily require or imply any actual relationship or order between these entities or operations. Moreover, terms "include", "include" or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by a phrase "including a" does not exclude that there are other same elements in the process, method, object or device including the element.

The steps of a method or an algorithm described in conjunction with the embodiments disclosed herein may be directly implemented by hardware, a software module executed by a processor, or a combination thereof. The software module may be placed in a random access memory (RAM), an internal memory, a read-only memory (ROM), an electrically programmable ROM, an electrically erasable programmable ROM, a register, a hard disk, a removable magnetic disk, a CD-ROM, or any other form of storage medium known in the technical field.

It should be noted that the embodiments of the present application do not involve sensitive information of a user, and even if the related information of the user is used, the related information of the user is acquired, used and determined after being authorized by the user.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the present application. Therefore, the present application will not be limited to the embodiments shown herein, but rather to the widest scope consistent with the principles and novel features disclosed herein.

1. A rendering method, comprising:
performing, on a first object in a multi-object material, rendering of a first effect to obtain a first rendering result;
performing, on a second object in the multi-object material, rendering of a second effect to obtain a second rendering result;
obtaining a target rendering result of the multi-object material based on the first rendering result and the second rendering result, wherein the first object in the target rendering result presents the first effect, and the second object in the target rendering result presents the second effect.

2. The method of claim 1, wherein the performing, on the first object in the multi-object material, the rendering of the first effect to obtain the first rendering result comprises:
performing, based on a first rendering function renderGroup corresponding to the first object, conversion processing on the first object to obtain first information corresponding to the first object, the first information comprising the first object in a picture format;
performing, on the first object in the picture format, effect processing corresponding to the first effect to obtain the first rendering result.

3. The method of claim 1, wherein the performing, on the second object in the multi-object material, the rendering of the second effect to obtain the second rendering result comprises:
performing the rendering of the second effect on the multi-object material to obtain the second rendering result, and the first object in the target rendering result presents the first effect and the second effect.

4. The method of claim 1, wherein the obtaining the target rendering result of the multi-object material based on the first rendering result and the second rendering result comprises:
saving the first rendering result into a slot corresponding to the first object, and saving the second rendering result into a slot corresponding to the second object;
obtaining the target rendering result based on contents in the slots corresponding to respective objects in the multi-object material.

5. The method of claim 4, wherein the obtaining the target rendering result based on the contents in the slots corresponding to respective objects in the multi-object material comprises:
performing, based on the contents in the slots corresponding to respective objects in the multi-object material, rendering of a third effect on the multi-object material to obtain the target rendering result, the first object in the target rendering result presents the first effect and the third effect, and the second object in the target rendering result presents the second effect and the third effect.

6. The method of claim 5, wherein the performing, based on the contents in the slots corresponding to respective objects in the multi-object material, the rendering of the third effect on the multi-object material to obtain the target rendering result comprises:
performing, for contents in slots corresponding to respective objects in the multi-object material, conversion processing on the multi-object material to obtain second information corresponding to the multi-object material, the second information comprising the multi-object material in a picture format;
performing, on the multi-object material in the picture format, effect processing corresponding to the third effect to obtain the target rendering result.

7. The method of claim 1, wherein the multi-object material further comprises a third object, and the method further comprises:
performing, on the third object, the rendering of the first effect to obtain a third rendering result corresponding to the third object;
saving the first rendering result and the third rendering result into a same slot, the slot corresponding to the first object or the third object.

8. The method of claim 1, wherein the multi-object material further comprises a fourth object, and the method further comprises:
in response to setting a state of the fourth object to a first value, not presenting the fourth object in the target rendering result, a state of an object being the first value indicating that the object is not rendered.

9. The method of claim 1, wherein the multi-object material is a text, and the first object is a character in the text; or, the multi-object material is a picture, and the object is a sticker or a local image in the picture.

10. An electronic device, wherein the electronic device comprises: a processor and a memory;
the memory is configured to store instructions or a computer program;
the processor is configured to execute the instructions or the computer program in the memory to cause the electronic device to perform a rendering method, comprising:
performing, on a first object in a multi-object material, rendering of a first effect to obtain a first rendering result;
performing, on a second object in the multi-object material, rendering of a second effect to obtain a second rendering result;
obtaining a target rendering result of the multi-object material based on the first rendering result and the second rendering result, wherein the first object in the target rendering result presents the first effect, and the second object in the target rendering result presents the second effect.

11. The electronic device of claim 10, wherein the performing, on the first object in the multi-object material, the rendering of the first effect to obtain the first rendering result comprises:
performing, based on a first rendering function renderGroup corresponding to the first object, conversion processing on the first object to obtain first information corresponding to the first object, the first information comprising the first object in a picture format;
performing, on the first object in the picture format, effect processing corresponding to the first effect to obtain the first rendering result.

12. The electronic device of claim 10, wherein the performing, on the second object in the multi-object material, the rendering of the second effect to obtain the second rendering result comprises:
performing the rendering of the second effect on the multi-object material to obtain the second rendering result, and the first object in the target rendering result presents the first effect and the second effect.

13. The electronic device of claim 10, wherein the obtaining the target rendering result of the multi-object material based on the first rendering result and the second rendering result comprises:
saving the first rendering result into a slot corresponding to the first object, and saving the second rendering result into a slot corresponding to the second object;
obtaining the target rendering result based on contents in the slots corresponding to respective objects in the multi-object material.

14. The electronic device of claim 13, wherein the obtaining the target rendering result based on the contents in the slots corresponding to respective objects in the multi-object material comprises:
performing, based on the contents in the slots corresponding to respective objects in the multi-object material, rendering of a third effect on the multi-object material to obtain the target rendering result, the first object in the target rendering result presents the first effect and the third effect, and the second object in the target rendering result presents the second effect and the third effect.

15. The electronic device of claim 14, wherein the performing, based on the contents in the slots corresponding to respective objects in the multi-object material, the rendering of the third effect on the multi-object material to obtain the target rendering result comprises:
performing, for contents in slots corresponding to respective objects in the multi-object material, conversion processing on the multi-object material to obtain second information corresponding to the multi-object material, the second information comprising the multi-object material in a picture format;
performing, on the multi-object material in the picture format, effect processing corresponding to the third effect to obtain the target rendering result.

16. A non-transitory computer-readable storage medium, wherein the computer-readable storage medium stores instructions, and the instructions, when executed by a processor, cause the processor to perform a rendering method, comprising:
performing, on a first object in a multi-object material, rendering of a first effect to obtain a first rendering result;
performing, on a second object in the multi-object material, rendering of a second effect to obtain a second rendering result;
obtaining a target rendering result of the multi-object material based on the first rendering result and the second rendering result, wherein the first object in the target rendering result presents the first effect, and the second object in the target rendering result presents the second effect.

17. The non-transitory computer-readable storage medium of claim 16, wherein the performing, on the first object in the multi-object material, the rendering of the first effect to obtain the first rendering result comprises:
performing, based on a first rendering function renderGroup corresponding to the first object, conversion processing on the first object to obtain first information corresponding to the first object, the first information comprising the first object in a picture format;
performing, on the first object in the picture format, effect processing corresponding to the first effect to obtain the first rendering result.

18. The non-transitory computer-readable storage medium of claim 16, wherein the performing, on the second object in the multi-object material, the rendering of the second effect to obtain the second rendering result comprises:
performing the rendering of the second effect on the multi-object material to obtain the second rendering result, and the first object in the target rendering result presents the first effect and the second effect.

19. The non-transitory computer-readable storage medium of claim 16, wherein the obtaining the target rendering result of the multi-object material based on the first rendering result and the second rendering result comprises:
saving the first rendering result into a slot corresponding to the first object, and saving the second rendering result into a slot corresponding to the second object;
obtaining the target rendering result based on contents in the slots corresponding to respective objects in the multi-object material.

20. The non-transitory computer-readable storage medium of claim 19, wherein the obtaining the target rendering result based on the contents in the slots corresponding to respective objects in the multi-object material comprises:
performing, based on the contents in the slots corresponding to respective objects in the multi-object material, rendering of a third effect on the multi-object material to obtain the target rendering result, the first object in the target rendering result presents the first effect and the third effect, and the second object in the target rendering result presents the second effect and the third effect.
